(19) United States
(12) Patent Application Publication
(10) Pub. No.: US 2022/0170621 A1
(43) Pub. Date: Jun. 2, 2022

(54) Cabinet Lighting

(71) Applicants: Farzad Moghiman, Markham (CA); Ahmad Amiri, Richmond Hill (CA)

(72) Inventors: Farzad Moghiman, Markham (CA); Ahmad Amiri, Richmond Hill (CA)

(21) Appl. No.: 17/106,024

(22) Filed: Nov. 27, 2020

(51) Int. Cl. F21V 23/06; H05B 45/40; F21V 33/00

(52) U.S. Cl. CPC F21V 23/06; F21Y 2115/10; F21V 33/0012; H05B 45/40

(57) ABSTRACT

Inside of Kitchen Cabinets, Wardrobes and the like can be Lit, preferably with LED Bars under or over the Shelves and or Cabinet walls. But powering said Bars by cabling requires boring holes in the cabinet to run cables, uses space and moving lit shelves easily inside the cabinet is difficult. One Solution is use of Power Band(s), with one, two, three or more Exposed power carrying Traces over said Cabinet wall(s), touched firmly by conductive Springs installed at one or both ends of each Bar to transmit power from to LED on same Bar. One end of said coil or strip Springs is attached to the Bar and another free to touch and press upon said Traces which are connected to and carry electricity from a power source. Easier lifting of LED and Lenses, easy fixing of Linear LED Bars to Dry Walls are also proposed.

### PRIORITY

This Application Claims the Priority of U.S. Provisional Application 62/942,028 Filed 2019 Nov. 29.

### PROBLEMS TO SOLVE

Prior art lightings for inside of kitchen, storage, clothing or other cabinets use cables and wires to light the LED or other lights inside, which wires are cumbersome and unsightly to install and also to replace or relocate the cabinet shelves. Prior art Lifting of LED Lenses, removal of LED from inside Channels or Grooves they are typically entrenched, fixing of Linear LED Bars to Dry Wall or similar Panels are also cumbersome.

### SUMMARY OF THE INVENTION

This Invention introduces Power Bars for the LEDs which have Spring action Connectors that touch conductive Traces on Power Bans installed over the cabinet's inner walls, replacing the wires. The Invention also introduces mechanisms for easier lifting of LED Lenses, easier removal of LED from inside Channels or Grooves they are typically entrenched, and easier fixing of Linear LED Bars to Dry Wall or similar Panels and more.

### BRIEF DESCRIPTION OF THE DRAWINGS/FIGS. BY THEIR NUMBER

FIG. 1—Wireless Power Induction

FIG. 2—Light Bar(s)

FIG. 3—Motion Sensors

FIG. 4—Power Bar Cross Section

FIG. 5—Under Mounted Light Bars and Movable Shelves

FIG. 6—Light Bars with Strip Springs

FIG. 7—Light Bar Coil Spring Mechanism

FIG. 8—Side and Top Views of Light Bar's Coil Spring Tips

FIG. 9—Side and Top Views of Light Bar's Strip Spring with one end unattached

FIG. 10—Power Band over a Cabinet inner wall and Light Bars over Shelf surfaces

FIG. 11—Power Bar & its Cross Section with Grooves for Traces inside a Cabinet+Light Bars over

FIG. 12—Wireless Power Supply Source Beaming Directionally inside a Cabinet

FIG. 13—Wireless Power Supply Source Spreading power inside a Cabinet

FIG. 14—Laser Power Source for Beaming onto a photo electric cell

FIG. 15—Light Bar along a Cabinet walls joint corner

FIG. 16—A Light Bar's Semi-Tube, Lens, Cap and holding/attachment Clip

FIG. 17—A Light Bar's Semi-Tube, Lens, Cap and Clip assembly, underneath view

FIG. 18—A Light Bar's Semi-Tube, Lens, Cap and Clip assembly, side view

FIG. 19—A Light Bar's Semi-Tube, Lens, Cap, Clip Cross Section with screw tips to lift the Lens

FIG. 20—Light Bar's Semi-Tube, Lens, Cap, Clip and Screw, installed on a surface and inside a

FIG. 21—Light Bar installed inside a channel/groove, using a conventional clip

FIG. 22—Light Bar installed inside a channel/groove, using a Narrow Clip for tight installation

FIG. 23—Sealed/Waterproof Light Bar Lens, Semi-Tube and holding/attachment Clip

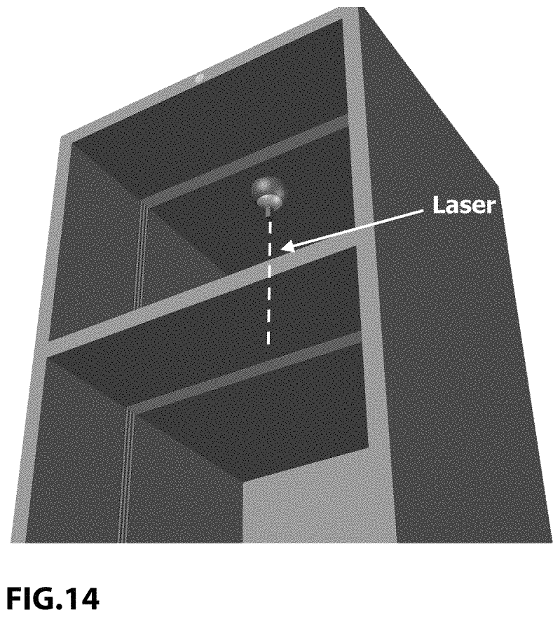

FIG. 14—Sealed/Waterproof Light Bar Lens, Semi-Tube and Clip Assembly

FIG. 25—Sealed Light Bar Assembly with Screw Tips inserted to remove the Lens

FIG. 26—Sealed Light Bar Lens almost removed from top

FIG. 27—Light Bar installed inside a channel over a (Dry Wall) Panel, with back of panel holding

FIG. 28—Panel holding Springs' attachment mechanism to the underneath of Light Bar

FIG. 29—Dry Wall holding Springs' attachment mechanism to the underneath of Light Bar—alternate

FIG. 30—Panel holding Springs' attachment mechanism to the underneath of Light Bar—Cross

### CONTRIBUTIONS BY INVENTOR 1

Inside of Kitchen Cabinets can be Lit, preferably with LED Bars (light strips or tapes, typically but not necessarily on a rigid support) under the Shelves or the Cabinet. LEDs are controlled for light Intensity, Colour and other features via a LED Control box.

One Problem is that powering said Bars by cabling requires boring holes in the cabinet to run cables, occupies valuable space, is expensive, is unsightly, and have other issues.

Another Problem is that users cannot move the lit shelves easily inside the cabinet.

Note: Sizes on Figs are examples only.

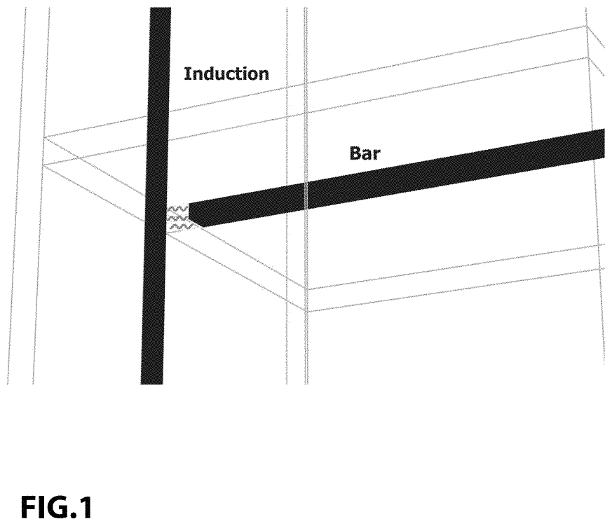

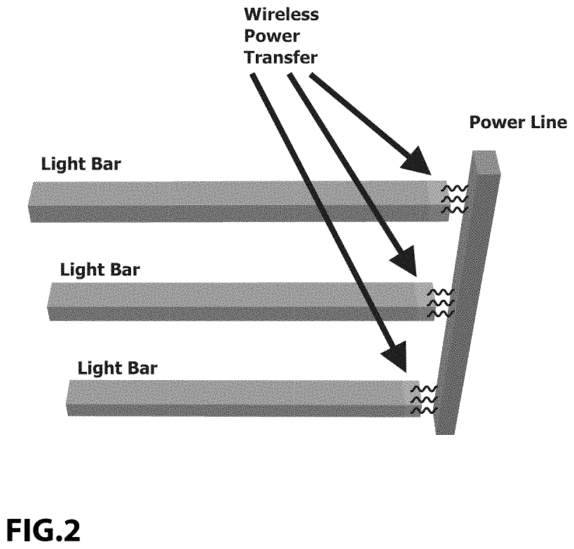

Solution 1—Using Wireless Power Transmission (Induction), (FIG. 1) known to the skilled, by running Inductive Power Source Bands along the cabinet Walls (sides, top and or bottom walls), and Inductive Power Receptors at one or both ends of at least some said Bars, which Bands and Bars are intrenched inside Channels along said walls, not to steal usable cabinet space. (FIG. 2)

Solution 2—Said Bars can have LEDs that shed light away from the eyes of a person opening the cabinet door, for better vision.

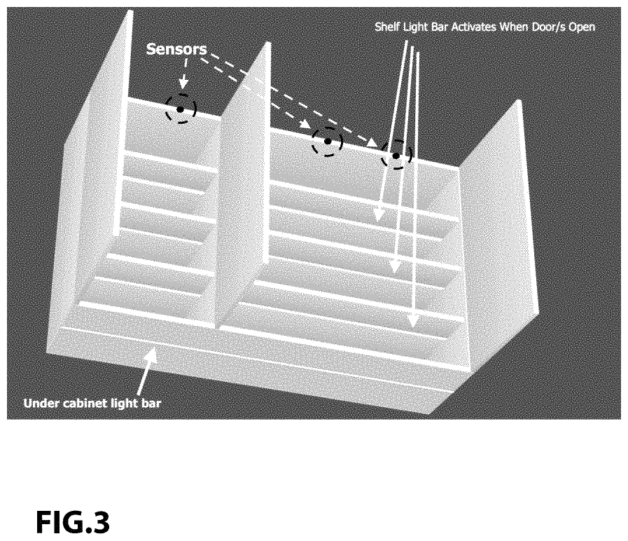

Solution 3—There are sensors installed on the cabinet walls or shelves that will turn the lights on when its door is opened and off when shut. (FIG. 3)

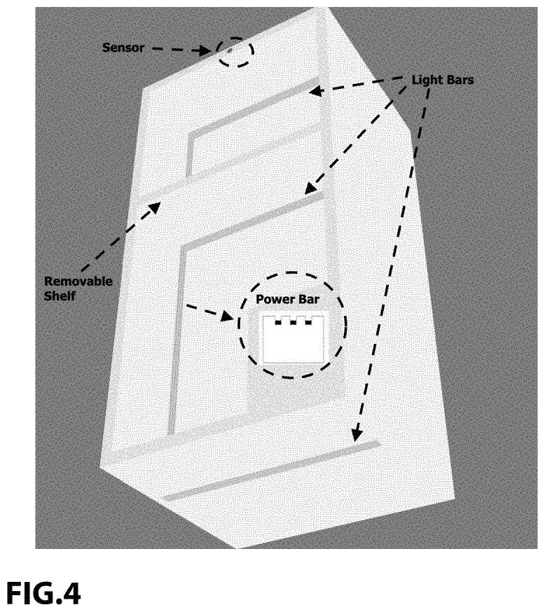

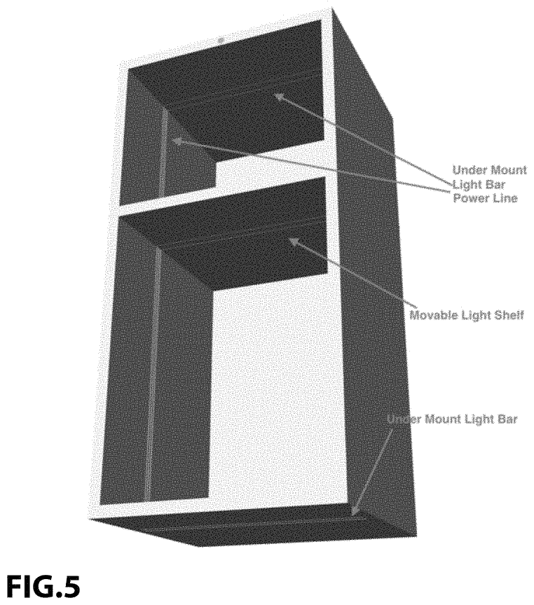

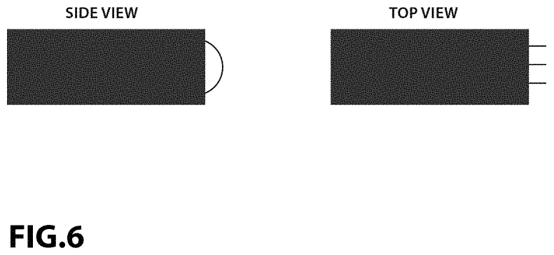

Solution 4—Power Band(s), with one, two, three or more Exposed power carrying Traces entrenched inside Grooves on said Bands, which Bands are dug inside Channels over Cabinet wall(s), to save usable shelf and or cabin space (FIG. 4). Said exposed traces are touched firmly by conductive Strip Springs installed at one or both ends of each Bar to transmit power from said traces to the LED on same Bar (FIG. 5). Said Strips have one end immovably attached to the Bar and another unattached and free to move into a slit at the end of the Bar when the Strip is pushed against said Traces. (FIG. 6)

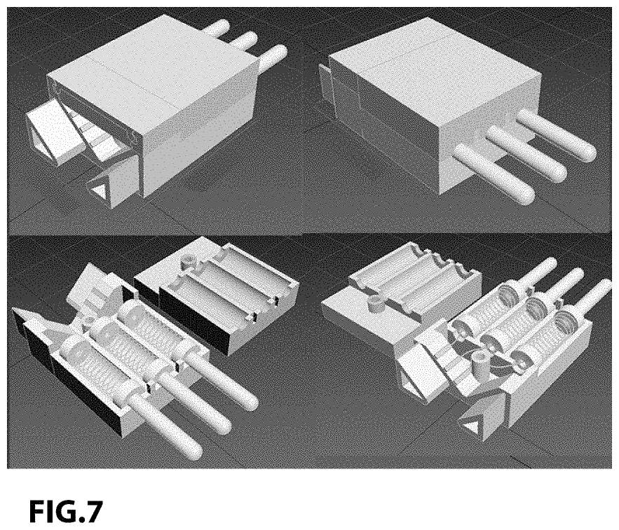

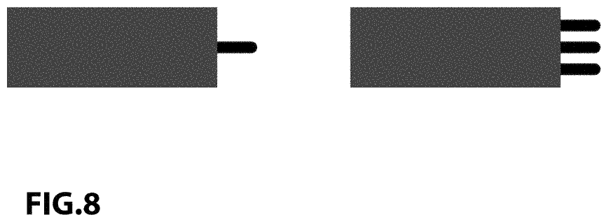

Solution 5—An alternative to said Strip is Compression Springs forcing power receptor heads against the traces. (FIG. 7, 8)

### CONTRIBUTIONS BY INVENTOR 2

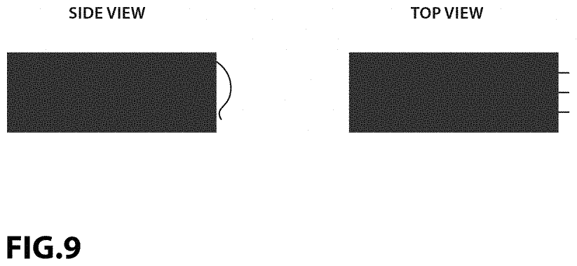

Solution 6—Connector Strip(s) to transmit power from traces to a Bar, having one end immovably attached onto or rooted on the Bar, and the other end free to slide over the end of the Bar, to allow the spring to change shape, to fit between the Bar and the Trace it is connecting to. (FIG. 9)

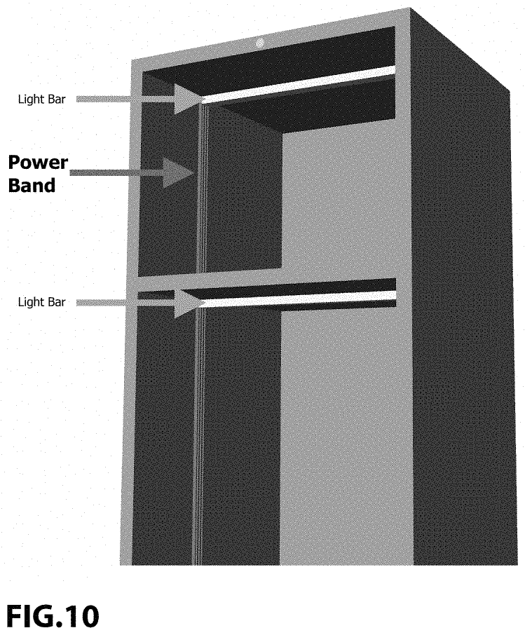

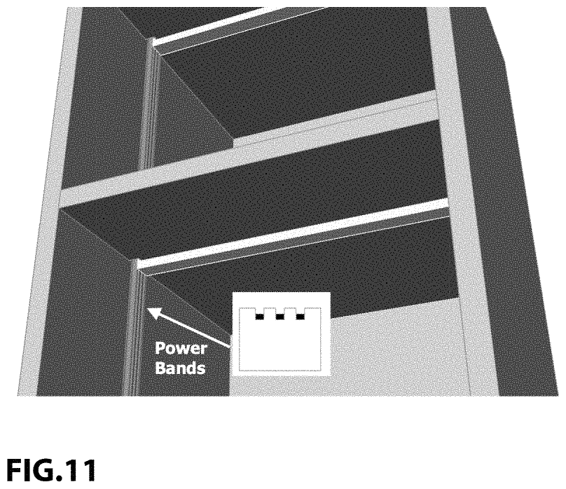

Solution 7—To enable Retrofitting existing Cabinets with Light Bars, without carving channels along Cabinet walls or shelves, said Bars can be Slim and attached over the surface(s) of cabinet walls and or shelves. (FIG. 10, 11)

Solution 8—To enable Retrofitting existing Cabinets with Power Bands, without carving channels along Cabinet walls or shelves, said Bands can be Slim and attached over the surface(s) of cabinet walls and or shelves, and if desired or needed, the shelves are dented at their ends to accommodate tangenting Bands

Solution 9—Traces can also be laid over the surface of the Band, to reduce Band thickness, in which case simple means, known to the skilled, can be incorporated to prevent said Strips to slide off said traces. and the other end is free to slide.

Solution 10—Attachment of Retrofitting Bars and or Traces to the cabinet walls and or shelves can be by any means, such as Glue, Sticking Bands with one or both surfaces peeling to expose an adhesive, Screws, Velcro, Magnetized metal, rubber or other Sheet(s), Dye or similar, on one and or both attaching surfaces, while the opposite surface being attached thereto is of one of above substances.

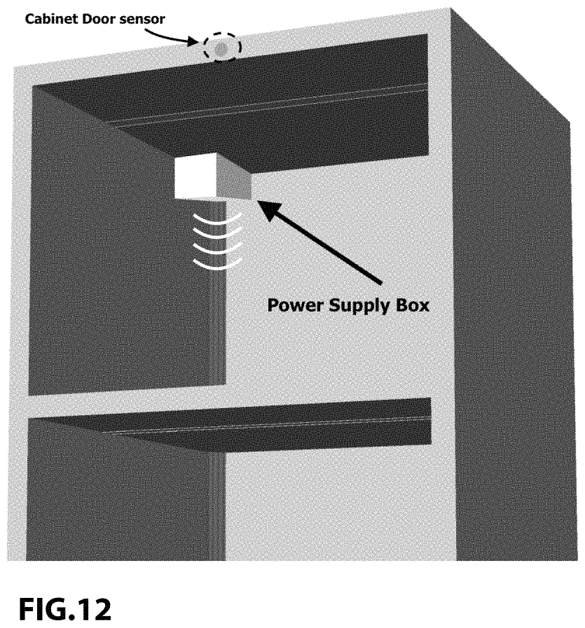

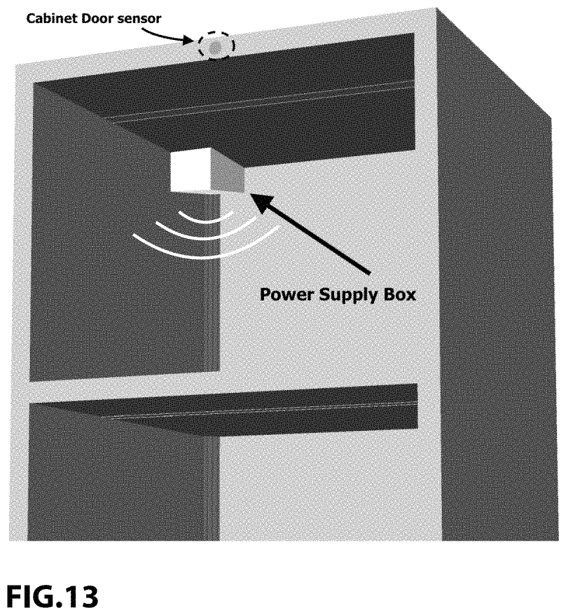

Solution 11—Remote Wireless Power Transmission (RWPT) to the Bars, via a Power Casting Source inside or close to the cabinet, which spreads electromagnetic waves to feed any number of Bars. (FIG. 12, 13)

Solution 12—RWPT, instead of being distributed spherically or widely, can have means to Beam corridor like or tubular, laser or laser like, or even focusing rays, which do not spread wide, but maintain direction, such that almost all of the Beam arrives at the receiving Bar, to reduce loss.

Solution 13—RWPT Wavelengths may be chosen to pass through the barriers, such as shelves or cabin walls, between source and receptor. (FIG. 14)

Solution 14—RWPT can be visible, laser or other light that generates power in a Photocell installed over the Bar or the LED.

Solution 15—Bars can be fitted with preferably slim Batteries, to store RWPT and induction power transmitted.

Solution 16—Source(s) of Electromagnetic Waves, including laser, visible and invisible light, can be on a support, many versions known to the skilled, that enables changing and fixing the direction of the emitted beam, to hit or reach the intended receptor, to enable aiming at different receptors or changing the location of receptor.

Solution 17—Slim electrical wire strips or ribbons known to the skilled, instead of cords and cables, is one of many ways that power can be fed to LEDs, for similar results as RWPT or power Bands.

Solution 18—Motion Detectors can be installed in the Cabinet to sense a user's motion and turn the Bars on, and can be adapted to sense and or act only the intended Cabinet, not the adjacent ones.

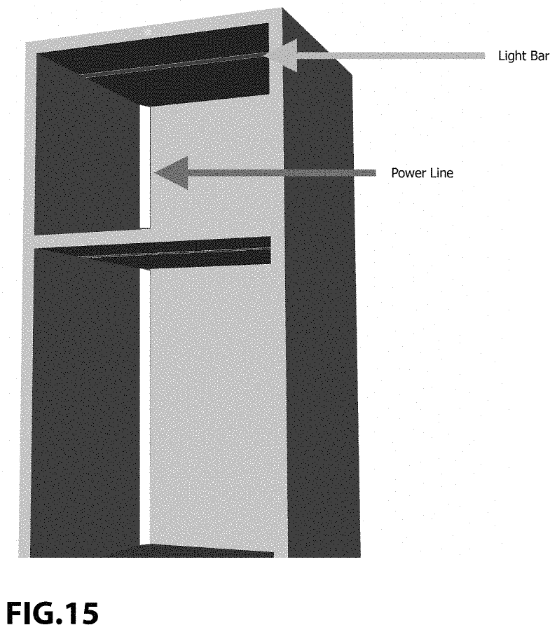

Solution 19—Any of components, be it Bars, Bands, Traces, Electrical Wire Strips, Controls, Cables, Batteries, etc., can be inside or over the surface(s) of a rectangular or preferably triangular Prism running along the junction of cabin's walls and or wall & shelf. (FIG. 15)

Solution 20—Technologies introduced here can be applied to Wardrobes, Open Shelves and the like.

Solution 21—Any combinations or permutations of other Solutions here.

### Further Contributions by Inventor 1

### Linear Light with easy to lift Lens and Hidden Attachment Clips

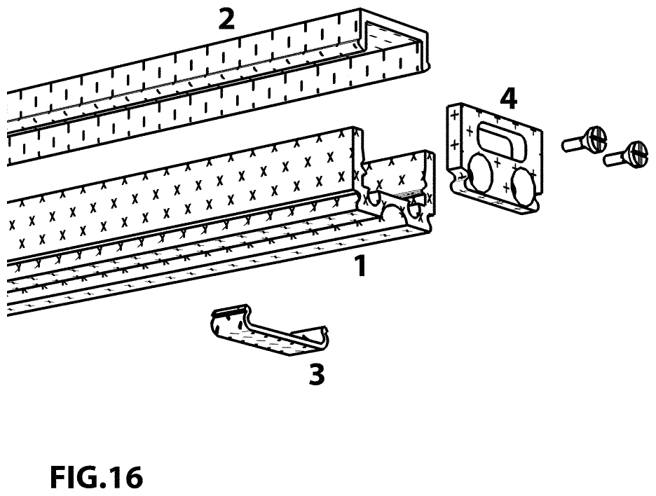

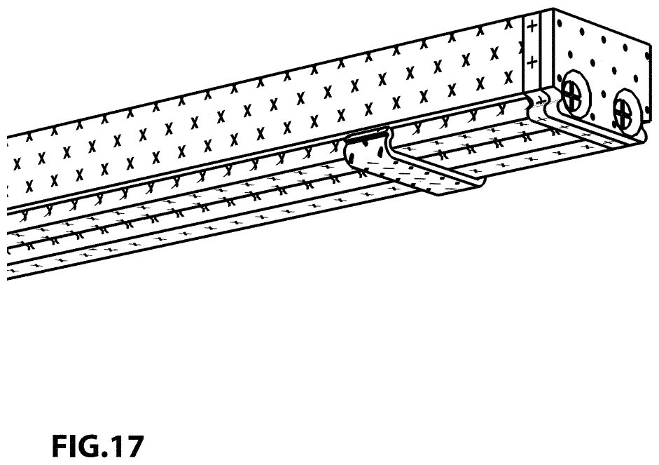

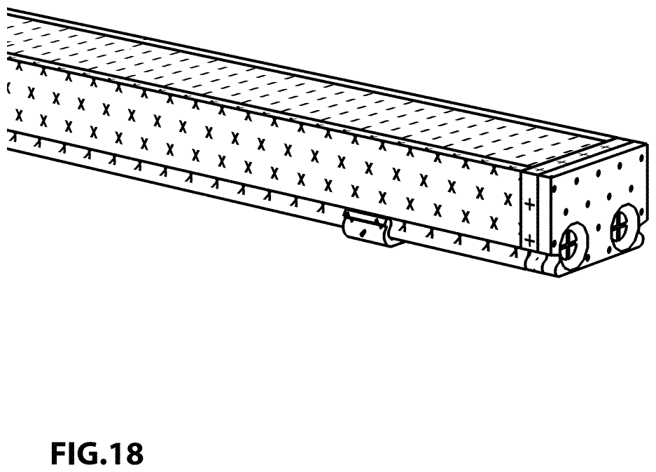

A Semi-Tube with a U, Semi-Circle or similar Cross Section as in FIG. 16-1 inside which a linear light source, typically of LED or its variations is laid, which Semi-Tube is covered by a lid like Lens as in FIG. 16-2, the bottom of said Semi-Tube is snapped into a spring action U-Shaped Holder as in FIG. 16-3 and the ends are capped by a Cap as in FIG. 16-4 which cap is usually screwed where a segment of said Semi-Tube is terminated. Said structure is further illustrated by FIG. 17 and FIG. 18.

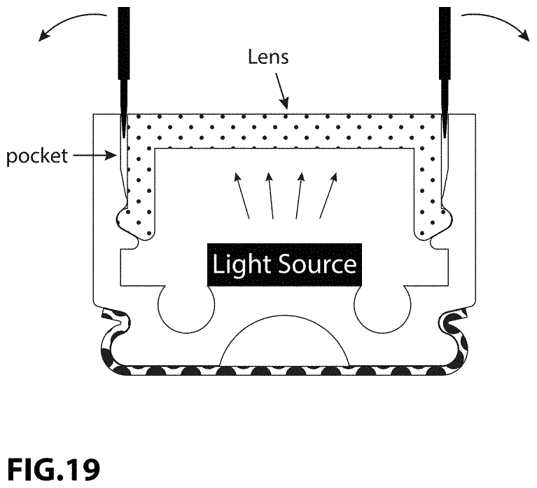

Removing of prior art Lenses is possible only by sliding the Lens along and off said Semi-Tube, which requires uninstalling the Semi-Tube too, unless in situations where there is an open space at the end of the Tube for a finger to firmly press against said end. This invention provides for a Lens which when installed over and in the Semi-Tube, there will be gaps or pockets as in FIG. 19 in which gaps a small screwdriver or similar tool can be inserted to lift the Lens off the Semi-Tube, from anywhere along the length of the Semi-Tube.

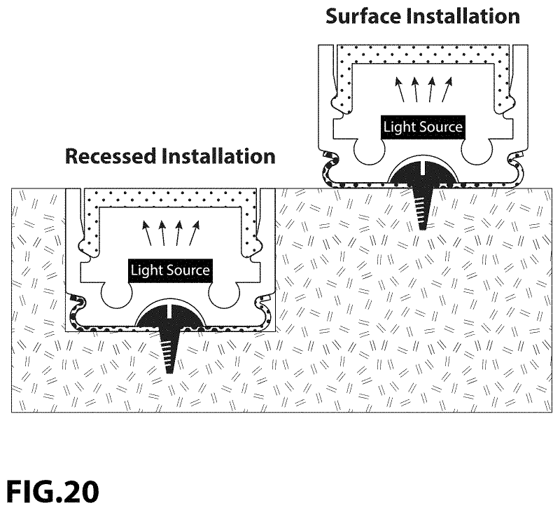

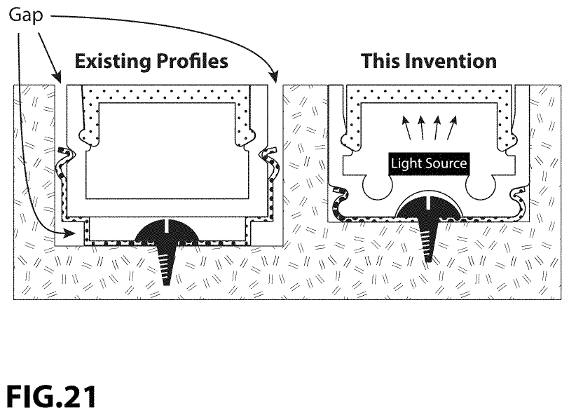

The Semi-Tube can be installed on a desired surface or inside a pre-carved groove (recessed mounted) (FIG. 20). Using clips to install the prior art linear Semi-Tubes (FIG. 21) creates the following challenges:
1. The groove has to accommodate the width of the clips which are greater than the width of the Semi-Tube (FIG. 21) This creates gaps on both sides of the Semi-Tube when it is installed.
2. The screws used to secure the clips to the surface create a gap between the base of the Semi-Tube and the surface on which the Semi-Tube is mounted. Consequently, the fixture does not sit flush with the surface or the groove needs to be carved deeper. However, the latter option is not feasible as the deep groove reduces the surface resistance and increases the brittleness of the surface (usually a shelf with a specific thickness).

Therefore using the clips to secure the Semi-Tube is not feasible.

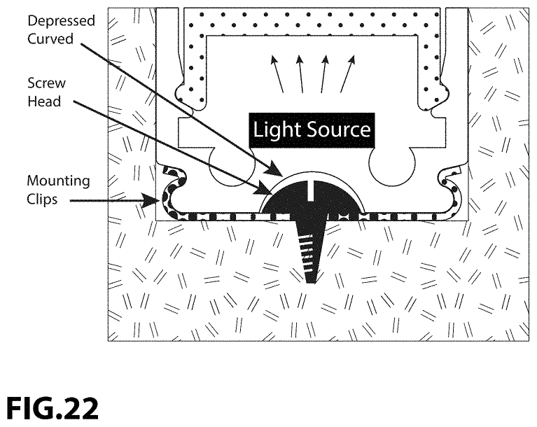

In this Invention, (FIG. 22) the limitations of using the clips are removed:
1. Mounting clips are designed with a width that does not exceed the Semi-Tube width and therefore looks hidden.
2. The Semi-Tube is secured to the desired surface by being placed into clips, which are screwed or adhered to the surface. The screw heads would normally create gaps between the clip and the surface. However, in this Inventions the Semi-Tube has a depressed curved groove running along its length on the backside to accommodate the screw heads. Therefore, when the Semi-Tube is installed there are no gaps between the Semi-Tube and the surface.

A waterproof Lens tube is designed for this light when it is installed in wet locations. For this application, the light source is run through the Lens tube, and the tube Lens is then installed onto the Semi-Tube. The prior art waterproof tube Lenses have some problems that cause limitations for installation and light maintenance. The LED light inside the Lens tube can not be installed and cannot be removed when the Semi-Tube is installed and fixed in place, even if the ends of the tube is reachable by fingers. The entire Semi-Tube has to be removed in order to install or replace the LED inside the Lens tube. Here are the two problems faced when using the prior art Lens tubes:
1. The installer needs to slide the Lens along the length of the Semi-Tube for installation as the Lens can not be inserted onto the Semi-Tube from the top.
2. The installer also needs to slide the Lens along the length of the Semi-Tube for removal as the Lens can not be removed from the top.

One reason for above 1 & 2 points is that prior art water proof Lens tubes have extrusions that fill the cavities on the sides of the Semi-Tube shown in FIG. 25-1 & FIG. 25.2, which this Inventions does without as shown in FIG. 25.

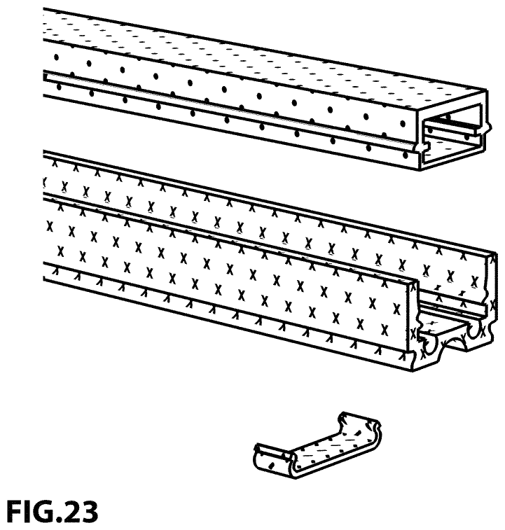

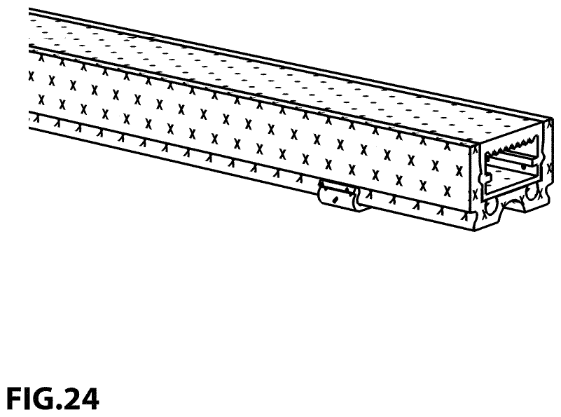

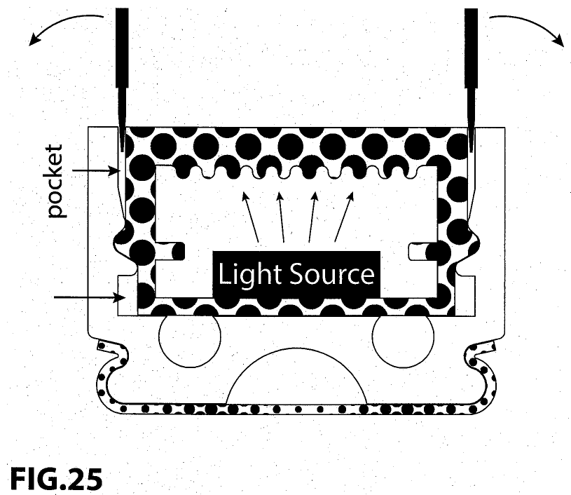

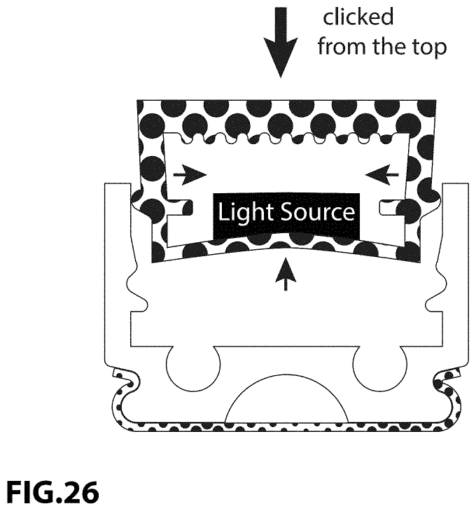

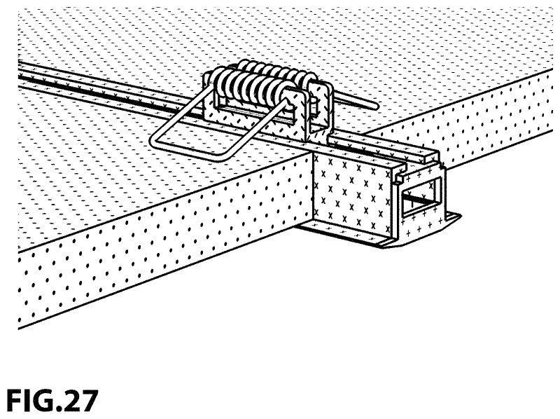

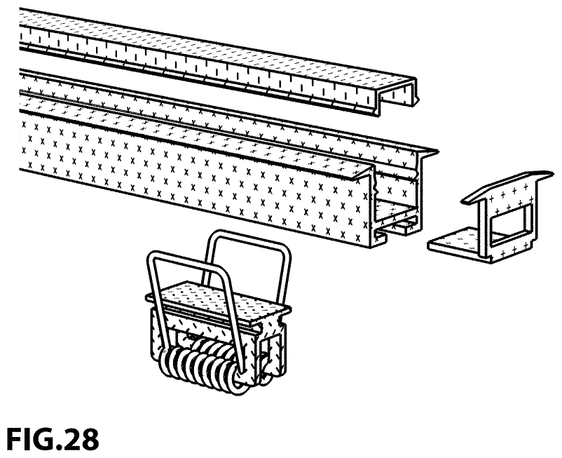

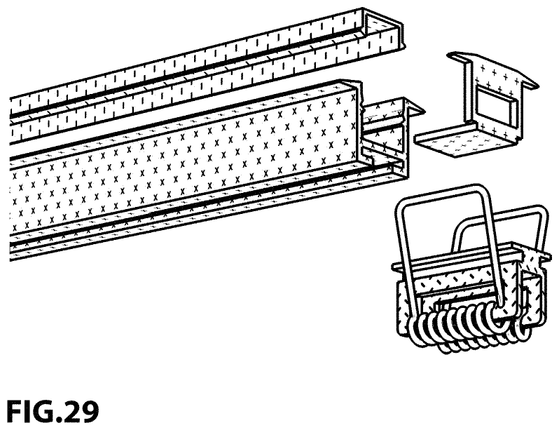

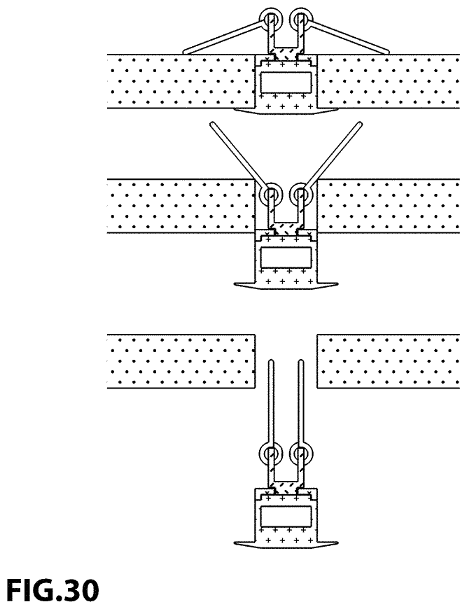

The Semi-Tube and Lens (both regular and Lens tube) of this Invention (FIG. 23) address the above-mentioned problems:
1. They are designed such that when the Lens is installed, one or two gap(s) or pocket(s) are created on the sides along the length of the fixture. Said gaps enable the installer to remove the Lens easily and install or replace the LED while the Semi-Tube is fixed in place. (FIG. 22)
2. The Lens can be inserted from the top into the Semi-Tube. The Lens with the same functionality can be produced in different widths for a variety of Semi-Tube widths (FIG. 25).

### Linear Light with the same Thickness as the Drywall and easy Installation Clips

This linear light (FIG. 27 to FIG. 30) is designed to be installed in drywall without the need to use screws. It is also easily removable to get access to inside of the wall.
1. The Semi-Tube depth is substantially the same as the thickness of the surfaces such as drywall it is intended to be installed, and therefore there is no need for any manipulations beyond the drywall.
2. The “spring clip” width is smaller than the Semi-Tube housing width and there is no need to cut the surface wider or deeper than the Semi-Tube housing
3. The Semi-Tube and Lens are designed so that when the Lens is secured to the Semi-Tube, a hidden gap (pocket) is created on one side or both sides across the length of the fixture. The pockets enable the installer to remove the Lens easily from anywhere across the length of the Semi-Tube to access the inside of the Semi-Tube for maintenance

1. A cabinet shelving system with lighting inside a Cabinet comprising:
at least one removable, relocatable and or replaceable Shelf with one or more low profile, typically LED Lighting Bar(s) attached thereto, wherein at least one of said Bar(s) has electrical conductive lines connected to conductive Spring(s) affixed to at least one end of the corresponding at least one of said Bar(s);
one or more electro-conductive Trace stretched over inner surface of at least one wall of said Cabinet, said Traces being connected to a low-voltage sparkless Power Source;
wherein upon placing a removable shelf, each of the corresponding conductive Spring(s) forcibly touch exposed one of the electro-conductive Traces, whereby cumbersome electrical cabling to said Bars when placing, removing, replacing and or relocating the bars or their harbouring removable shelf within the Cabinet is avoided.

2. Claim 1 where at least one of said springs are coil springs with a Tip for contact with said traces.

3. Claim 1 where at least one of said springs are curved and strip like, one of the two larger surfaces of said strip faces and can touch said traces, and both ends of said strip are fixed to said bar.

4. Claim 1 where at least one of said springs are curved and strip like, one of the two larger surfaces of said strip faces and can touch said traces, one ends of said strip is fixed to said bar and the other end free to slide over the bar, to conform more easily to the space available for said strip between the bar and said traces.

5. Claim 1 where at least one of said bars are entrenched inside a channel over a surface of said shelf.

6. Claim 1 where at least one of said traces is inside a dedicated groove into which one of said springs need to enter to touch said trace, whereby chances of said spring touching said cabinet wall off the intended trace is reduced.

7. Claim 1 where at least one of said traces are over a Band, to be called a power Band.

8. Claim 1 where at least one of said traces are entrenched inside a channel over an inner surface of a cabinet wall, whereby the need for carving, caving or denting the thickness of tangenting shelf(s) is reduced or eliminated.

9. Claim 1 where at least one of said traces is inside a dedicated groove into which one of said springs need to enter to touch said trace, at least one of said grooves are over a Band, to be called a power Band and at least one of said bands are entrenched inside a channel over an inner surface of a cabinet wall.

10. Claim 1 where the electrical power supply has a voltage adaptor to convert main supply voltage to below what would case sparks when said conductive springs touch said traces.
